(19) United States
(12) Patent Application Publication
(10) Pub. No.: US 2011/0157468 A1
(43) Pub. Date: Jun. 30, 2011

(54) TELEVISION RECEIVER AND METHOD FOR SAVING ENERGY THEREOF

(75) Inventor: Lung Dai, Tu-Cheng (TW)

(73) Assignee: HON HAI PRECISION INDUSTRY CO., LTD., Tu-Cheng (TW)

(21) Appl. No.: 12/890,821

(22) Filed: Sep. 27, 2010

(30) Foreign Application Priority Data
Dec. 25, 2009 (TW) 98145201

(51) Int. Cl. H04N 5/63; H04N 5/44; H04N 7/00; H04N 5/50

(52) U.S. Cl. 348/552; 348/553; 348/730; 725/40; 348/E05.127; 348/E05.1

(57) ABSTRACT

A television receiver includes an indentifying unit and a comparator. The indentifying unit indentifies a category of a currently tuned television program. The comparator determines whether the currently tuned television program belong to predetermined particular categories, and generates a first cut-off signal to stop video signals from being displayed on the television and to allow audio signals output on the television if the currently tuned television program belong to the predetermined particular categories.

### BACKGROUND

1. Technical Field

The present disclosure relates to digital television technology, and particularly to a television receiver and a method for saving energy applied in the television receiver.

2. Description of Related Art

Television receivers display images whenever they are in use. However, users may just want to listen to the audio output of the television without having any displayed images in order to conserve power or save energy.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block function diagram of a television receiver in accordance with an exemplary embodiment.

FIG. 2 is schematic diagram illustrating how to classify television programs into categories in accordance with an exemplary embodiment.

FIG. 3 is a flow chart of a method for saving energy applied in a television receiver in accordance with an exemplary embodiment.

### DETAILED DESCRIPTION

The present disclosure provides a television receiver applying a method for saving energy to selectively switch to an audio only mode according status of users. As a result, reducing wasteful use of energy by the television receiver is possible.

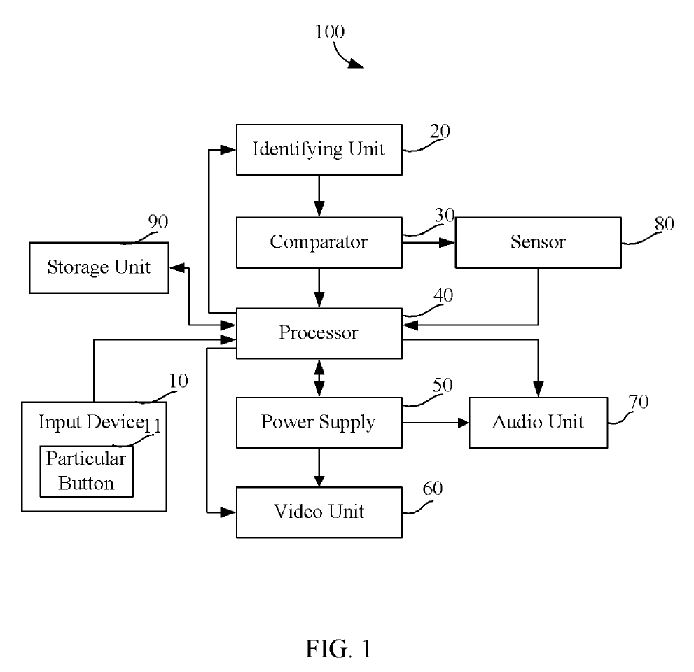

Referring to FIG. 1, a television receiver 100, such as a STB (set top box), is capable of reproducing digital television signals on a screen (not shown). The digital television signals are transmitted together with an Electronic Program Guide (hereinafter, referred to as EPG). An EPG provides an overview of present and future television programs. For each television program, the EPG provides information such as a channel on which the program will be broadcast, the scheduled start time, length, title, description, etc.

The television receiver 100 includes an input device 10, an identifying unit 20, a comparator 30, a processor 40, a power supply 50, a video unit 60, an audio unit 70, a sensor 80, and a storage unit 90. The processor 40 is configured to provide audio and video signals to the video unit 60 and the audio unit 70 correspondingly. The power supply 50 is configured to provide operating power to the video unit 60 and the audio unit 70.

The input device 10 is configured to generate user commands in response to user operations. The input device 10 includes a particular button 11 that can be selected to generate an energy saving signal to activate or deactivate an energy saving function of the television 100. The input device 10 may be a button module located on the television receiver 100 and/or on a remote controller (not shown) of the television receiver 100.

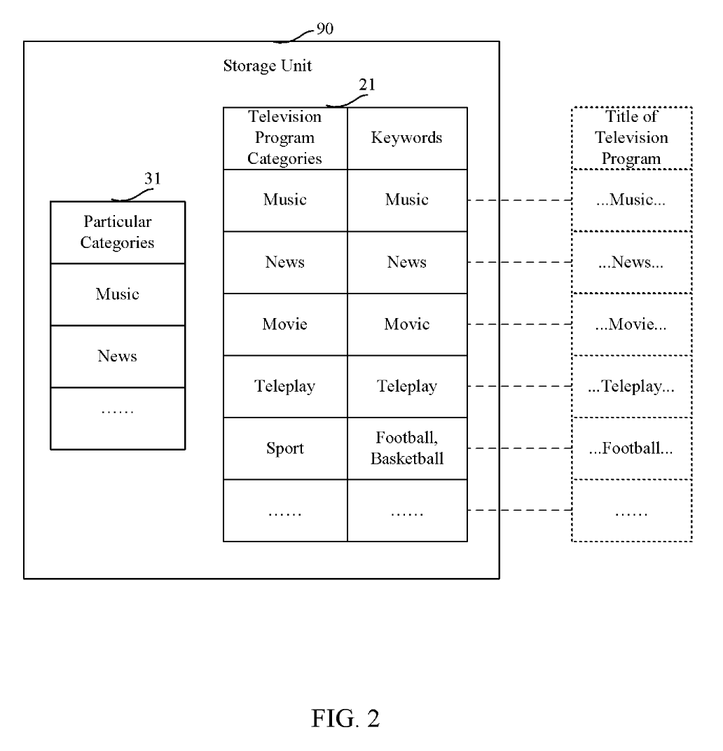

Referring to FIG. 2, the storage unit 90 is configured to store a category table 21 to classify television programs into categories. For example, each television program may be classified by keywords that are associated with categories such as movie, music, teleplay, news, sports etc. The storage unit 90 further stores a particular category table 31 to determine if a television program is audio-centric. That is some shows such as music programs or news shows may be considered to be audio-centric because little information is imparted to a viewer visually, whereas a movie may be considered visual-centric. Any categories considered to be audio-centric are listed in the particular category table 31.

The indentifying unit 20 is configured to respond to the energy saving signal by extracting EPG information of a currently tuned television program, and indentify a category of the television program based on the extracted EPG information, such as a title of the television program. For example, the indentifying unit 20 compares the title of the television program with the keywords of the category table 21 to determine the television program category to which the television program belongs. For example, if the title of the television program is “ . . . music . . . ”, the word music in the title is a keyword associated with the music category. Likewise, if the title of the television program is “ . . . news . . . ”, the word news in the title is a keyword associated with the news category.

The comparator 30 is configured to determine whether the category of the currently tuned television program is one of the particular categories listed in the particular category table 31. The comparator 30 is configured to generate a first cut-off signal if the category of the currently tuned television program is listed in the particular category table 31.

The processor 40 is further configured to control the power supply 50 to cut off the electric power to the video unit 60 in response to the first cut-off signal. As a result, the television receiver 100 automatically enters an audio only mode to save energy. It is understood that, the television 100 can be manually placed in audio only mode or taken out of audio only mode by operation of the input device 10.

Furthermore, the television receiver 100 may further include a sensor 80. The sensor 80 is an infrared sensor which can detect infrared signals from a human body within a predetermined range around the television receiver 100. The comparator 30 generates a detecting signal if the comparator 30 determines that the category of the currently tuned television program is not listed in the table 31. The sensor 80 is configured to determine whether a user is within the predetermined range for a predetermined time by detecting infrared signals in response to the detecting signal. The sensor 80 is further configured to generate a second cut-off signal if no user is within the predetermined range for the predetermined time. The processor is further configured to control the power supply 50 to cut off power to the video unit 60 and the audio unit 70 in response to the second cut-off signal. As a result, the television receiver 100 enters a standby mode and is unable to reproduce the audio and the video signals. In this way if a user leaves the room and the currently tuned program is not in table 31 then it is assumed that the user is not listening to the television 100 from another room and the television 100 automatically enters the energy saving standby mode. In some embodiments the television 100 can be configured to keep checking for users in the predetermined range and exit standby mode when someone is detected or in other embodiments the television 100 stays in standby mode until the input device 10 is operated.

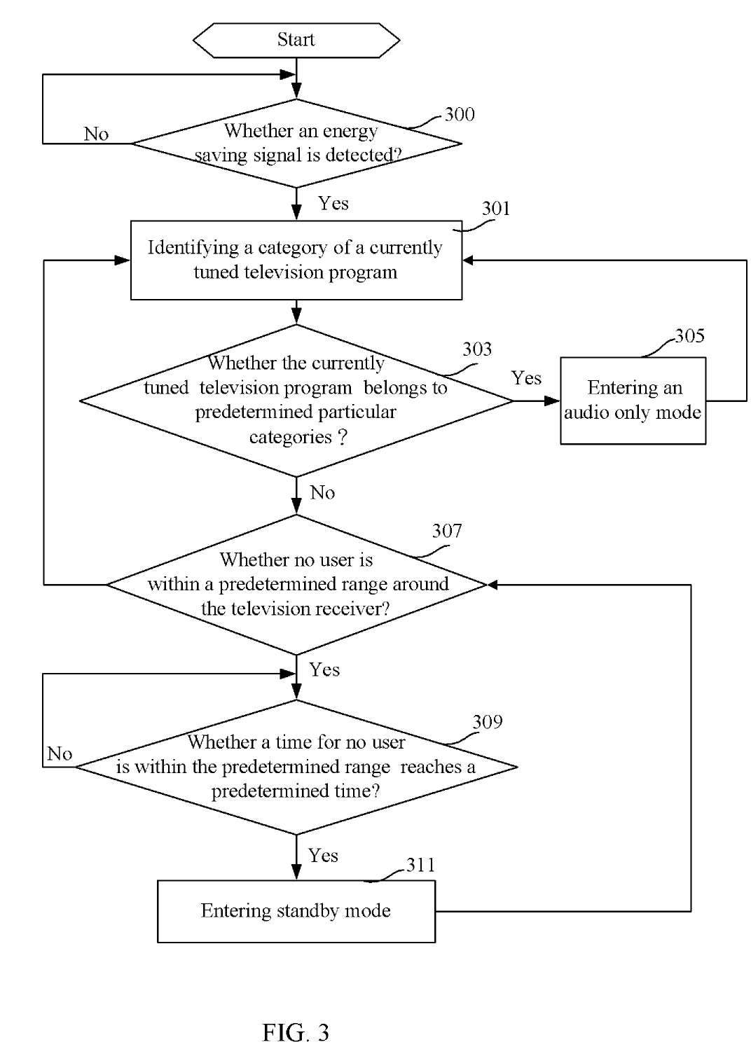

Referring to FIG. 3, a method for saving energy applied in a television receiver is illustrated. The television receiver includes a power supply, an audio unit, and a video unit. The power supply supplies electric power to the audio unit and the video unit. The audio unit reproduces audio signals. The video unit reproduces video signals. The method for saving energy includes the following step.

In step 300, determining whether an energy saving signal is detected. For example, manipulating or setting a particular button on the television receiver or a remote control device, if a user operates the particular button, the energy saving signal will be input into the television receiver that the energy saving signal is detected.

In step 301, obtaining television program information of a currently tuned television program, and indentifying a category of currently tuned television program based on the television program information. For example, a plurality of television program categories and keywords that are associated with television program categories may be preset in the television receiver. Obtaining the television program information is performed by extracting EPG information of the television program. The obtained television program information includes a title of the television program. Indentifying the category of the currently tuned television program is performed by comparing the title of the currently tuned television program with the keywords. For example, if the title of the currently tuned television program includes a keyword associated with one of the television program categories, the category of the currently tuned television program is determined to belong to the associated one of the television program categories.

In step 303, determining whether the currently tuned television program belongs to predetermined particular categories. For example, the predetermined particular categories are pre-set in the television receiver. The predetermined particular categories include categories considered to be audio-centric. That is some shows such as music programs or news shows may be considered to be audio-centric because little information is imparted to a viewer visually, whereas a movie may be considered visual-centric. Determining whether the category of the currently tuned belongs to the predetermined particular categories is performed by comparing the category of the currently tuned television program with the predetermined particular categories. For example, if the category of the currently tuned television program is identical with one of the predetermined particular categories, the currently tuned television program is determined to belong to the predetermined particular categories.

In step 305, entering an audio only mode if the currently tuned television program belongs to the predetermined particular categories. For example, entering an audio only mode is performed by cutting off electric power to the video unit of the television receiver.

In step 307, determining whether no user is within a predetermined range around the television receiver. Determining whether no user is within a predetermined range around the television receiver is performed by setting a sensor in the television receiver. The sensor is capable of detecting infrared signals from the human body who are away from the sensor within the predetermined range. For example, if the sensor has detected infrared signals, it is determined that, no user located within the predetermined range around the television receiver.

In step 309, determined whether a time for no user is within the predetermined range around the television receiver reaches a predetermined time if no user is within a predetermined range around the television receiver.

In step 311, entering standby mode if the time reaches the predetermined time. The television receiver enters the standby mode is that the television receiver is unable to reproduce the audio and the video signals. For example, entering standby mode is performed by cutting off electric power supplied to the video unit and the audio unit of the television receiver.

It is to be understood, however, that even though information and advantages of the present embodiments have been set forth in the foregoing description, together with details of functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A television receiver comprising:
an indentifying unit to indentify a category of a currently tuned television program; and
a comparator to determine whether the currently tuned television program belongs to predetermined particular categories, and generate a first cut-off signal to control the television receiver to enter an audio only mode if the currently tuned television program belongs to the predetermined particular categories.

2. The television receiver of claim 1, further comprising:
a video unit to reproduce the video signals;
a power supply to provide electric power to the video unit; and
a processor to control the power supply to cut off the electric power to the video unit in response to the first cut off signal.

3. The television receiver of claim 1, wherein the indentifying unit identifies the category of the currently tuned television program based on the information of the currently tuned television program.

4. The television receiver of claim 1, wherein the predetermined particular categories comprise television program considered to be audio-centric.

5. The television receiver of claim 1, wherein the predetermined particular categories comprise news category and music category.

6. The television receiver of claim 1, further comprising a sensor, the comparator being configured to generate a detecting signal if the currently tuned television program does not belong to the predetermined particular categories, the sensor being configured to detecting whether no user is within a predetermined range around the television receiver in response to the detecting signal, and generate a second cut-off signal to control the television receiver to enter a standby mode to be unable to reproduce video signals and audio signal if the sensor detects that no user is within the predetermined range for a predetermined time.

7. The television receiver of claim 6, further comprising:
a video unit to reproduce the video signals;
an audio unit to reproduce the audio signals;
a power supply to provide electric power to the video unit; and
a processor to control the power supply to cut off the electric power to the video unit and the audio unit in response to the second cut off signal.

8. The television receiver of claim 6, further comprising an input device to manipulate the television receiver, the input device includes a particular button to be operable to generate an energy saving signal, the indentifying unit to identify the category of the currently tuned television program in response to the energy saving signal.

9. A method for saving energy applied in a television receiver comprising:
identifying a category of a currently tuned television program;
determining whether the currently tuned television program belongs to predetermined particular categories;
controlling the television receiver to enter an audio only mode, if the currently tuned television program belongs to the predetermined particular categories.

10. The method for saving energy of claim 9, wherein identifying the category of the currently tuned television program is based on information of the currently tuned television program.

11. The method for saving energy of claim 10, wherein the information of the currently tuned television program comprises title of the currently tuned television program.

12. The method for saving energy of claim 9, wherein the method for saving energy before performing the step of identifying the category of the currently tuned television program comprise following steps:
determining whether an energy saving signal is detected;
identifying a category of the currently tuned television program if the energy saving signal is detected.

13. The method for saving energy of claim 9, further comprises steps of:
determining whether no user is within a predetermined range around the television receiver if the currently tuned television program does not belong to predetermined particular categories;
determining whether a time for no user is within the predetermined range reaches a predetermined time if the no user r is within the predetermined range;
controlling the television receiver to enter a standby mode to be unable to reproduce video signals and audio signals, if the time for no user is within the predetermined range reaches the predetermined time.

14. The method for saving energy of claim 9, wherein the predetermined particular categories comprise television programs considered to be audio-centric.

15. The method for saving energy of claim 9, wherein the predetermined particular categories comprises news category and music category.
